(19) United States
(12) Patent Application Publication
(10) Pub. No.: US 2002/0050059 A1
(43) Pub. Date: May 2, 2002

(54) Chip feed device and method of feeding semiconductor chips

(76) Inventor: Uwe Waeckerle, Bruchsal (DE)

Correspondence Address: SCHIFF HARDIN & WAITE, 6600 SEARS TOWER, 233 S WACKER DR, CHICAGO, IL, 60606-6473, US

(21) Appl. No.: 09/961,003

(22) Filed: Sep. 21, 2001

(30) Foreign Application Priority Data
Sep. 21, 2000 (DE) 10046899.3

(51) Int. Cl. B23P 19/00

(52) U.S. Cl. 29/832; 29/739

(57) ABSTRACT

In a chip feed device and a method of feeding semiconductor chips from a substantially flat wafer having a plurality of semiconductor chips, the wafer is arranged with the active side facing downward, the wafer is positioned relative to the removal position so that a semiconductor chip to be removed is arranged above the removal position, then the semiconductor chip to be removed is removed downward from the wafer, and is transported from the removal position to a transfer position.

### BACKGROUND OF THE INVENTION

The invention relates to a chip feed device and a method of feeding semiconductor chips from a substantially flat wafer having a plurality of semiconductor chips.

Semiconductor chips are conventionally provided in large numbers on a wafer. In order to be able to process one of the semiconductor chips further in each case, the wafer is arranged with the active side facing upward, that is to say with the side on which the semiconductor chips are accessible via connecting areas or connecting elements, and the wafer is adhesively bonded to a thin sheet. Then, the silicon wafer prepared in this way is sawed up, so that the separate semiconductor chips can be removed separately. One type of semiconductor chip, after being removed, is set on a substrate with the active side facing upward, and the connecting areas or connecting elements of the chip are then connected from above by thin conductors, which extend to the connecting points on the substrate, by means of known wire bonding devices.

In recent times, semiconductor chips have been developed which, on their active side, have connecting spheres (bumps) or other connecting elements. During the further processing, these are placed with the active side facing downward onto connecting points on a substrate, and these points are often arranged in the manner of a matrix. Since, for production technical reasons, the semiconductor chips continue to be arranged in the wafer with the active side facing upward, they have to be pivoted or rotated in order to place them on to the substrate, so that the active side points downward. For this application, as a rule “flippers” or pivoting devices are integrated into conventional die-bonding devices.

When processing a plurality of “flip-chips” on a wafer, each semiconductor chip is first removed from the wafer by a pick-up device, then pivoted or rotated through 180° about a substantially horizontal axis and then transferred to the actual handling device, which performs the arrangement on the substrate.

However, systems of this type are very slow. In addition, pivoting the semiconductor chip constitutes a complicated intermediate step with an increased failure rate.

### SUMMARY OF THE INVENTION

The object of the invention is to provide a chip feed device and a method of feeding semiconductor chips in which the disadvantages of the prior art are avoided.

This object is achieved by a chip-feed device by which at least one substantially flat wafer having a plurality of semiconductor chips can be picked up. The chip-feed device has a removal position with a removal devise for removing a semiconductor chip, a transfer position space from the removal position having a handling device for handling a chip at the transfer position, a holding device for holding a wafer in the area of the removal position with the wafer being arranged in the holding device with the active side being oriented downward, and a transfer device for transporting a semiconductor chip from the removal position after it has been removed from the wafer to the transfer position.

The object is also achieved by a method of feeding semiconductor chips from a substantially flat wafer having a plurality of semiconductor chips comprising the steps of arranging the wafer with an active side oriented downward, positioning the wafer relative to a removal position so that a semiconductor chip to be removed is arranged at the removal position, removing the semiconductor chip at the removal position downward from the wafer and transporting the removed semiconductor chip from the removal position to a transfer station where it can be picked up by a handling device which can place it in either a housing or on a printed circuit board.

At least one substantially flat wafer having a plurality of semiconductor chips can be picked up by a chip feed device according to the invention. The chip feed device has a holding device for holding the wafer in the area of a removal position, and the wafer is arranged on the holding device with the semiconductor chip to be removed oriented downward, that is to say the active side of the semiconductor chip, on which contact can later be made with the semiconductor chip, is arranged to be oriented downward. In addition, the chip feed device according to the invention has a removal device for removing semiconductor chips from the wafer at the removal position. By means of a transport device, the semiconductor chips can be transported from the removal position to a transfer position. By arranging the wafers in such a way that the active side of the semiconductor chip is oriented downward, it is not necessary to turn the removed semiconductor chips for the further processing of the latter. As a result, according to the invention the step of turning the semiconductor chip is eliminated. This saves both processing time and the provision of a technically complicated turner station for the semiconductor chips. In addition, the chip feed device according to the invention has a lower failure rate.

According to the invention, the removed semiconductor chips can be moved substantially parallel to the plane of the wafer by means of the chip feed device. This permits a faster additional processing of the removed semiconductor chips.

Moreover, the wafer can be moved relative to the removal position by means of the chip feed device. As a result, by positioning the wafer with the semiconductor chip to be removed directly in the vicinity of the removal position, the removal of the respective semiconductor chip can be prepared.

The removal device of the chip feed device has, in particular, an ejector pin which is arranged at the removal position and above the wafer and also faces the transport device. By means of the ejector pin, the semiconductor chip to be removed can be lifted off the wafer so that it is picked up by means of a pick-up device, which is provided on the transport device, and can be moved from the removal position to the transfer position. The interaction of the ejector pin with the pick-up device permits reliable transfer of the semiconductor chip to be removed from the wafer to the transport device.

The transport device is preferably of cross-like design and can be rotated about an axis which is substantially perpendicular to the arms of the cross-like transport device and runs through the point of symmetry of the cross-like transport device. As a result, one or more pick-up devices, by means of which removed semiconductor chips can be moved between the removal position and the transfer position, can be arranged on each of the arms of the transport device.

The chip feed device according to the invention, together with the wafer, the removal device, the transport device and the pick-up devices, can be arranged horizontally or vertically or else inclined at any desired angle. A semiconductor chip removed from the wafer can be moved substantially parallel to the plane of the wafer, with the exception of small movements during the removal of the semiconductor chip from the wafer.

From the transfer position, the removed semiconductor chip can be transferred by means of a handling device, such as pick-and-place device, to arrange the semiconductor chips in a housing or on a printed circuit board.

According to the invention, semiconductor chips are flip-chips or other types of semiconductor chips which are fitted to a substrate or to a printed circuit board with the active side facing downward.

According to the invention, the method for feeding semiconductor chips from a substantially flat wafer provided with a plurality of semiconductor chips, comprises a first step of arranging all the wafers with the active side of the semiconductor chips facing downward. Then, for each semiconductor chip to removed, the next step includes positioning the chip of the wafer above a removal position, so that the semiconductor chip to be removed is located above the removal position. Then, the method includes the steps of removing the semiconductor chip to be removed downward from the wafer, and then transporting the removed semiconductor chip from the removal position to a transfer position.

In this case, turning the removed semiconductor chip is not necessary, and the removed semiconductor chip can be directly transported, without being turned, for example by means of a handling device, from the transfer position and then arranged directly in a housing for semiconductor chips or on a printed circuit board. The semiconductor chip is moved substantially parallel to the plane of the wafer. In particular, the semiconductor chip for the method according to the invention is a flip-chip or another semiconductor chip which is to be arranged with the active side facing downward in a housing or on a printed circuit board.

The invention will be explained in more detail with reference to the drawing.

### BRIEF DESCRIPTION OF THE DRAWINGS

FIG. 1 is a schematic side view of a preferred embodiment of the chip feed device according to the invention, and

FIG. 2 is a schematic plan view of the preferred embodiment of the chip feed device according to the invention.

### DESCRIPTION OF THE PREFERRED EMBODIMENTS

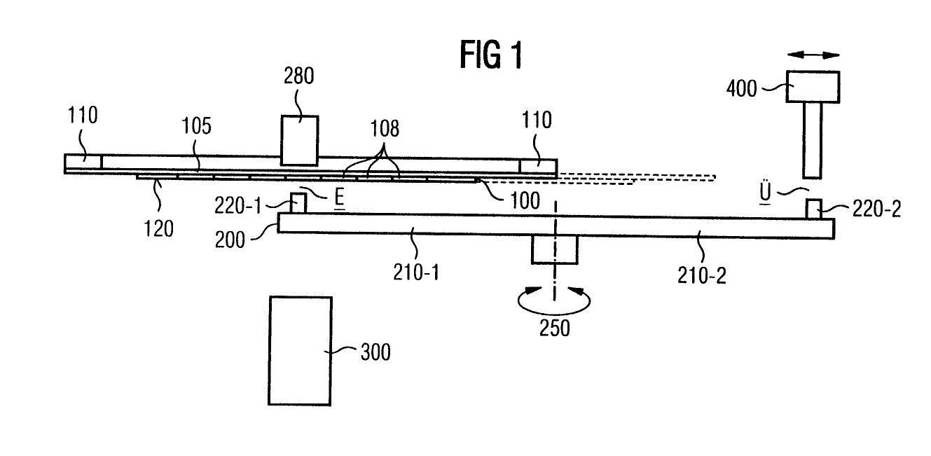

As FIG. 1 reveals, a preferred embodiment of the chip feed device according to the invention has a holding device 110, on which a wafer 100 is fixed to a thin sheet 105, for example by being adhesively bonded to the latter, and the wafer 100 can be arranged with the active side 120 oriented downward. By means of the holding device 110, the thin sheet 105 with the wafer 100 can be moved, substantially within the plane of the wafer, relative to a removal position E. The wafer 100 has a plurality of semiconductor chips 108, which form the active side 120 of the wafer and are accessible from this active side 120. The wafer 100 can, for example, be provided with the thin sheet 105 on its rear surface or side which faces away from the active side 120. In order to remove the semiconductor chips 108 from the wafer 100, the latter can be sawed up into individual segments, which correspond to the semiconductor chips 108. The thin sheet 105 is preferably fitted to the wafer 100 before the sawing operation. The segments separated from one another by sawing are held on the thin sheet 105 by means of an adhesive layer formed between the wafer 100 and the thin sheet 105. A semiconductor chip 108 to be removed is arranged close to the removal position E by means of the holding device 110. By means of an ejector pin 280, the semiconductor chip 108 to be removed can be removed from the wafer 100 from the rear of the wafer 100 by stretching the thin sheet 105 downward, and the chip 108 can be picked up by a pick-up device 220-1. In this case, the pick-up device 220-1 is likewise positioned in the vicinity of the removal position E and is arranged on a transport device 200. In addition to one or more pick-up devices 220-1 and 220-2, the transport device 200, which can be of cross-like design, has a plurality of arms 210-1, 210-2. The transport device 200 can be rotated about an axis 250, which runs substantially perpendicular to the arms 210-1, 210-2 and through the point of symmetry of the transport device 200. Underneath the transport device 200, a camera 300 can be arranged in the vicinity of the removal position E, and the removal of semiconductor chips from the wafer 100 by means of the ejector pin 280 and the pick-up device 220-1 can be monitored by means of the camera 300.

According to the preferred embodiment of the invention, the removed semiconductor chip 108 is picked up by the pick-up device 220-1 of the transport device 200 with the active side facing downward. The passive side of the removed semiconductor chip 108, facing away from the active side, points upward in this case. By means of the transport device 200, the removed semiconductor chip 108 with the passive side facing upward is transported from the removal position E to a transfer position Ü. At the transfer position Ü, the removed semiconductor chip 108 can be removed by a handling device 400, such as a pick-and-place device, as is usual in the case of die bonding devices or SMD fitting devices, and supplied to further processing equipment.

Since the removed semiconductor chip is transported to the handling device 400 with the passive side facing upward, additional pivoting of the semiconductor chip 108 is not necessary. The semiconductor chip 108 can be processed further directly by means of the handling device 400. For example, the semiconductor chip is transported by the handling device 400 above a housing, in which it is to be inserted with the active side facing downward and on which there are, for example, connecting bumps. It is also possible to place the removed semiconductor chip with the active side facing downward directly onto a printed circuit board.

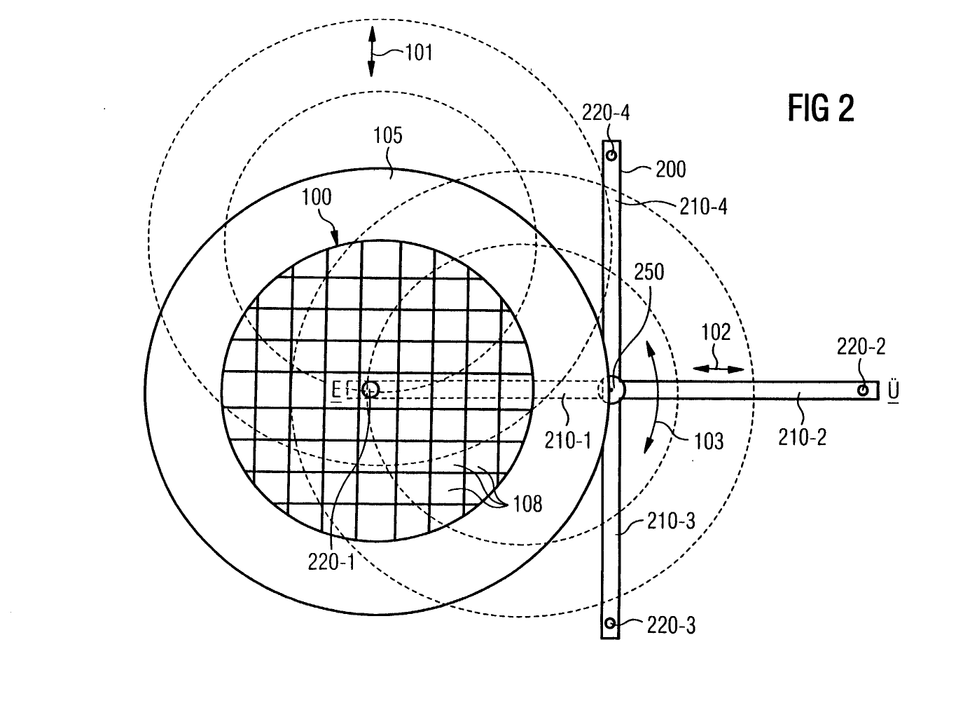

FIG. 2 reveals the relative movements of the wafer 100 with respect to the pick-up device 220-1 of the transport device 200, which can be carried out to position the wafer 100 to remove a semiconductor chip 108 above the removal position E, and which movement is illustrated by the arrows 101 and 102. In addition, the possible rotational movements of the transport device 200 about the axis 250 for transporting the removed semiconductor chip from the removal position E to the transfer position Ü are illustrated, as revealed by the arrow 103. In addition, it can be gathered from FIG. 2 that the transport device 200 as claimed in the preferred embodiment of the invention is of cross-like design and has four arms 210-1, 210-2, 210-3 and 210-4, which are each provided at their end section with a pick-up device 220-1, 220-2, 220-3 and 220-4. This makes it possible, during one revolution of the transport device 200, for four semiconductor chips 108, which have been removed from the wafer 100 by means of the ejector pin 280 and have been arranged on one of the pick-up devices 220-1, 220-2, 220-3 and 220-4, to be transported from the removal position E to the transfer position Ü. From the transfer position Ü, the removed semiconductor chips 108 can be processed further by means of a handling device 400 to further or additional processing by means of known devices belonging to flip-chip technology or else die bonding technology or SMD technology.

Although modifications and changes may be suggested by those skilled in the art, it is the intention of the inventor to embody within the patent warranted hereon all changes and modifications as reasonably and properly come within the scope of his contribution to the art.

I claim as my invention:

1. A chip feed device by which at least one semiconductor chip of a substantially flat wafer having a plurality of semiconductor chips can be picked up and placed, said device comprising:
a holding device for holding the wafer in the area of a removal position, the wafer being arranged on the holding device with an active side of the chip being oriented downward,
a removal device for removing the semiconductor chips from the wafer at the removal position, and
a transport device for transporting the semiconductor chips from the removal position to a transfer position.

2. A chip feed device according to claim 1, wherein the semiconductor chips are movable in planes parallel to the plane of the wafer.

3. A chip feed device according to claim 2, wherein the wafer is movable relative to the removal position by means of the holding device for the purpose of locating the semiconductor chip to be removed.

4. A chip feed device according to claim 3, wherein the removal device has an ejector pin, which is arranged above the wafer at the removal position and faces the transport device, and the transport device is arranged under the wafer and has at least one pick-up device which, together with the transport device can be moved relative to the removal position and relative to the transfer position, so that it is possible for the semiconductor chips to be removed from the wafer by the pick-up devices in cooperation with the ejector pin.

5. A chip feed device according to claim 4, wherein the transport device is crosslike with a plurality of arms and is rotatable about an axis which is substantially perpendicular to the arms and extends through a point of symmetry of the cross-like transport device.

6. A chip feed device according to claim 5, wherein one of the pick-up devices in each case is arranged on the end section of the arms of the cross-like transport device.

7. A chip feed device according to claim 6, which includes a handling device located at the transfer position to transfer a semiconductor chip from the transfer position and to arrange the semiconductor chips in a housing or on a printed circuit board.

8. A chip feed device according to claim 7, wherein the semiconductor chips are moved in a plane parallel to the plane of the wafer during the transfer.

9. The chip feed device according to claim 8, wherein the semiconductor chip is a flip-chip or a bare-die chip.

10. The chip feed device according to claim 1 wherein the wafer is movable relative to the removal position by means of the holding device for the purpose of removing the semiconductor chip.

11. A chip feed device according to claim 1, wherein the removal device has an ejector pin, which is arranged above the wafer at the removal position and faces the transport device, and the transport device is arranged under the wafer and has at least one pick-up device which, together with the transport device can be moved relative to the removal position and relative to the transfer position, so that it is possible for the semiconductor chips to be removed from the wafer by the pick-up device in cooperation with the ejector pin.

12. A chip feed device according to claim 11, wherein transport device is crosslike with a plurality of arms and is rotatable about an axis which is substantially perpendicular to the arms and extends through the point of symmetry of the cross-like transport device.

13. A chip feed device according to claim 12, wherein the pick-up devices in each case is arranged on the end section of the arms of the cross-like transport device.

14. A chip feed device according to claim 1, which includes a handling device located at the transfer position to transfer a semiconductor chip from the transfer position and to arrange the semiconductor chips in a housing or on a printed circuit board.

15. A chip feed device according to claim 14, wherein the semiconductor chip is moved in a plane parallel to the plane of the wafer during the transfer.

16. A method of feeding semiconductor chips from a substantially flat wafer having a plurality of semiconductor chips, said method comprising the steps of:
arranging the wafer with an active side facing downward,
positioning the wafer relative to a removal position, so that a semiconductor chip to be removed is arranged at the removal position,
removing the semiconductor chip to be removed downward from the wafer, and
transporting the removed semiconductor chip from the removal position to a transfer position.

17. A method according to claim 16, which includes picking up the semiconductor chip at the transfer position and then arranging the picked up chip in a housing or on a printed circuit board.

18. A method according to claim 17, which includes moving the semiconductor chip substantially parallel to the plane of the wafer.

19. A method according to claim 16, wherein the semiconductor chip is a flipchip or a bare-die chip.
